(19) United States
(12) Patent Application Publication
(10) Pub. No.: US 2025/0126207 A1
(43) Pub. Date: Apr. 17, 2025

(54) FRAMEWORK FOR MODALITY CONVERSION BETWEEN PHONE AND CHAT CONVERSATIONS

(71) Applicant: Richard Zhu, New York, NY (US)

(72) Inventor: Richard Zhu, New York, NY (US)

(21) Appl. No.: 18/913,125

(22) Filed: Oct. 11, 2024

Related U.S. Application Data
(60) Provisional application No. 63/543,999, filed on Oct. 13, 2023.

(51) Int. Cl. H04M 3/51; G06Q 30/015; G10L 13/047; G10L 15/183; G10L 15/22; G10L 15/30; H04L 51/02; H04L 51/58

(52) U.S. Cl. CPC H04M 3/5191; G06Q 30/015; G10L 13/047; G10L 15/183; G10L 15/22; G10L 15/30; H04L 51/02; H04L 51/58; H04M 2201/39; H04M 2201/40

(57) ABSTRACT

Systems and methods combining Speech to Text, a language model, and Text to Speech service agents to accept voice phone calls and respond to those voice phone calls via text, thereby enabling the multitasking benefits of chat-based while maintaining a voice-based connection with a user.

### CROSS REFERENCE TO RELATED APPLICATION

This application claims the benefit of the filing date of U.S. Provisional Patent Application No. 63/543,999 filed Oct. 13, 2023, the disclosure of which is incorporated herein by reference in its entirety.

### FIELD OF THE DISCLOSURE

The present disclosure relates generally to customer service voice/chat systems and, more particularly, to switching between voice and text communications for each of a plurality of received communications.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Customer services organizations, such as those providing information technology (IT) support, customer support, and so on operate in very competitive economic environments. As such, the use of off-shore customer representatives or agents is commonplace. Preferably such agents use chat-based services such as texting, short message service (SMS), and so on. Advantageously, chat-based services allow agents to multitask more effectively than-based services.

Unfortunately, these services are not well integrated and switching between chat-based services and voice-based services is not only not seamless, but also tends to be one way; namely, a user accessing a customer services link of an organization initially via chat and quickly thereafter via voice as the user exits the chat-based service in favor of “speaking to a human” in a voice-based service of the organization.

For a human agent to respond via both voice and text modalities, the agent would need to monitor both voice and text which may be less efficient than simply taking a voice call directly from the user. For an artificial intelligence (AI) agent to respond to both voice and text, the customer services organization would need to give the AI agent access to production databases so as to address the customer services needs of a user but potential risks of trusting an AI agent with such access may result in organizations being hesitant to implement such systems.

### SUMMARY OF THE INVENTION

Various deficiencies in the prior art are addressed below by the disclosed systems and methods combining Speech to Text, a language model, and Text to Speech service agents to accept voice phone calls and respond to those voice phone calls via text, thereby enabling the multitasking benefits of chat-based while maintaining a voice-based connection with a user. This provides substantially seamless transitioning between chat-based services and voice-based services for customer service agents such as artificial intelligence (AI) agents so as to engage with users accessing such customer services in a more efficient manner (e.g., customer service agents receiving user phone calls but responding to users via chat messages).

A method for sustaining one or more semi-or fully-autonomous conversations between at least one human and at least one artificial intelligence agent according to an embodiment comprises: (a) receiving first speech from a human; (b) converting the first speech to first text via a speech-to-text language model; (c) allowing an artificial intelligence (AI) agent to generate second text responsive to the first text via a generative language model operably linked to a first database, the database being a production database or a copy of a production database; (d) converting the second text to second speech via a text-to-speech language model; and (e) transmitting the second speech to the human.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a high level block diagram of a method for interacting with user voice data according to an embodiment;

FIG. 2 depicts a high level block diagram of a method for interacting with user chat/text data according to an embodiment; and

FIG. 3 depicts a high-level block diagram of a system suitable for use in implementing the various embodiments.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments, such as voice assistant systems and phone operator services.

Currently, customer support is known to be either purely via phone call or purely via text-based chat. The disclosed approach allows customer service agents to interact with both types of support requests (phone and text) via text chat.

Various embodiments enable seamless transitioning between chat-based services and voice-based services for customer service agents such as artificial intelligence (AI) agents so as to engage with users accessing such customer services in a more efficient manner. Various embodiments enable scenarios such as customer service agents receiving user phone calls but responding to users via chat messages.

Various embodiments combine Speech to Text, a language model, and Text to Speech service agents to accept voice phone calls and respond to those voice phone calls via text, thereby enabling the multitasking benefits of chat-based while maintaining a voice-based connection with a user. For example, various embodiments utilize a speech to text application programming interface (API), generative model such as Generative Pre-trained Transformer 3.5 (GPT-3.5), and text to speech API. A voice over IP (VOIP) layer is used to facilitate voice phone calls.

While text-based responses to voice input provided by the user are generated automatically by the generative model, a built-in time delay allows a human agent to intervene by typing via text chat. The human agent may also intervene in the absence of a time delay via toggling on buttons, requiring human confirmation before proceeding.

Various embodiments contemplate systems and methods for allowing modality transitioning in customer-support interactions, specifically between text and speech modalities. A sample instantiation of this system would be for customers to call in via phone and hold a real-time phone conversation with a customer service agent who interacts purely via text-based chat.

Various embodiments provide a framework for modality conversion between phone and chat conversations that provides a method for sustaining one or more semi-or fully-autonomous conversations between at least one human and at least one artificial intelligence agent. For example, various embodiments provide a software framework for converting from speech modalities to chat/text modalities and vice versa, with a key feature of sustaining a level of semi-to fully-autonomous conversation between one human and one artificial intelligence (AI) agent, or any other 1:1, 1:many, many: 1, or many:many conversation. The disclosed approach may be employed, inter alia, by SMEs with scalable customer service needs or large customer service/IT services firms.

Advantageously, various embodiments maintain a separate production database and cache database. The cache database is a deep copy of the production database and generated at appropriate time intervals, such as every few hours and upon the size of the production database and frequency of updates etc. The generative model may be allowed to generate functions that directly interact with this cache database. The diff (which captures any modifications in a computationally efficient way) between cache and production databases is manually reviewed in batches prior to applying these diffs (e.g., such as every few hours) and if all changes look acceptable, they are written to the production database.

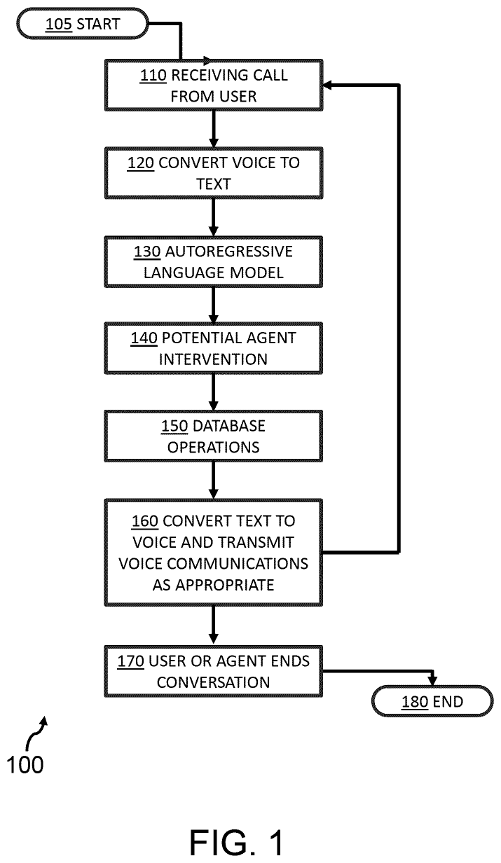

FIG. 1 depicts a high level block diagram of a method for interacting with user voice data according to an embodiment. Specifically, the method 100 of FIG. 1 is suitable for use by a customer service system receiving a customer service phone call from a human user, which phone call is are generally processed via an AI customer service agent as described herein with the possibility of intervention by a human customer service agent. The method 100 enables the sustaining of one or more semi-or fully-autonomous conversations between at least one human user and at least one AI agent, with the possibility of intervention by a human customer service agent.

The method 100 of FIG. 1 starts at step 105 such as in response to indication of an incoming voice communication from a user accessing customer service system.

At step 110, initial or subsequent voice data is received by the method 100.

At step 120, received voice data is converted to text data via a speech to text language model and, at step 130, processed by an autoregressive language model to generate thereby relevant autonomous responses. For example, the received text is passed through a generative language model which responsively provides one or many autonomous responses, which responses may include database queries that are valid for running on a copy of a production database or the production database itself. The production database holds customer data, order management data, and/or other customer related functions and data.

At step 140, potential human agent intervention in the customer service transaction is provided. That is, the AI agent may autonomously perform or continue to perform actions in response to customer inquiries, or a human agent may take over the conversation at any time by sending a message via a text-like interface.

At step 150, the database operations resulting from the interactions thus far in the customer service transaction may be implemented.

At step 160, text data indicative of an appropriate audio response or prompt from the AI agent or human agent is converted from text to speech and transmitted toward the user/customer such as via VoIP or other communications network. In the case of a human agent providing a voice response or prompt, that voice response or prompt is transmitted toward the user/customer. In the case of a human agent providing a text response or prompt, that text response or prompt is converted to a voice response or prompt and transmitted toward the user/customer.

Steps 110 through 150 are repeated until the user or agent terminates the conversation at step 170 and the method 100 terminates at step 180. It is noted that while steps 110 through 160 are depicted as occurring in a particular order, this order is not strictly necessary. For example, in various embodiments incoming audio information is converted to text processed by the AI agent (steps 110-130) while potential human intervention is provided (step 140).

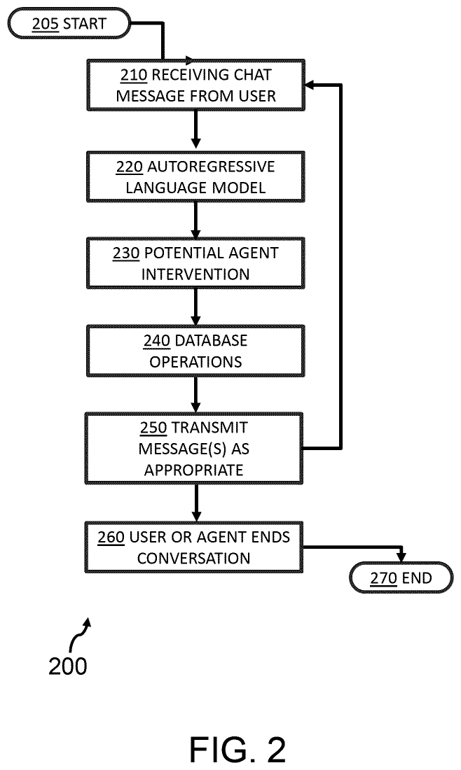

FIG. 2 depicts a high level block diagram of a method for interacting with user chat/text data according to an embodiment. Specifically, the method 200 of FIG. 2 is suitable for use by a customer service system receiving customer service messages (e.g., SMS) from a user, which messages are generally processed via an AI customer service agent as described herein with the possibility of intervention by a human customer service agent.

The method 200 of FIG. 2 starts at step 205 such as in response to indication of an incoming chat/text communication from a user accessing customer service system.

At step 210, initial or subsequent chat/text data is received by the method 200.

At step 220, the received text data is processed by an autoregressive language model to generate thereby relevant autonomous responses. For example, the received text is passed through a generative language model which responsively provides one or many autonomous responses, which responses may include database queries that are valid for execution on a copy of a production database or the production database itself. The production database holds customer data, order management data, and/or other customer related functions and data.

At step 230, potential human agent intervention in the customer service transaction is provided. That is, the AI agent may autonomously perform or continue to perform actions in response to customer inquiries, or a human agent may take over the conversation at any time by sending a message via a text-like interface.

At step 240, the database operations resulting from the interactions thus far in the customer service transaction may be implemented.

At step 250, text data indicative of an appropriate response or prompt from the AI agent or human agent is transmitted as toward the customer such as via VoIP or other communications network. In the case of a human agent providing a voice response or prompt, that voice response or prompt converted to a text response and transmitted toward the user/customer. In the case of a human agent providing a text response or prompt, that text response or prompt is transmitted toward the user/customer.

Steps 210 through 250 are repeated until the user or agent terminates the conversation at step 260, and the method 200 terminates at step 270. It is noted that while steps 210 through 250 are depicted as occurring in a particular order, this order is not strictly necessary.

It will be appreciated that the functions depicted and described herein may be implemented in hardware and/or in a combination of software and hardware, e.g., using a general purpose computer, one or more application specific integrated circuits (ASIC), specific arrangements of servers, computing devices, gateways and the like, or any other hardware equivalents or combinations thereof.

In various embodiments, computer instructions are loaded into memory resources and executed by compute/processing resources to implement the functions as discussed herein. The computer instructions (including associated data structures) can be stored on a computer readable storage medium, e.g., RAM memory, magnetic or optical drive or diskette, and the like.

It is contemplated that some of the steps discussed herein and above may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

Thus, various embodiments discussed above data may be implemented via code stored on a non-transitory computer readable medium or other memory resources associated with processing resources, a computing device implementing various functions such as described herein, such as configured to perform the methods such as by executing such code, by a special purpose device configured for performing the method and so on.

In various embodiments, computer instructions associated with a function of an element or portion thereof are loaded into a respective memory and executed by a respective processor to implement the respective functions as discussed herein. Such as in respective computing devices or entities or portions thereof.

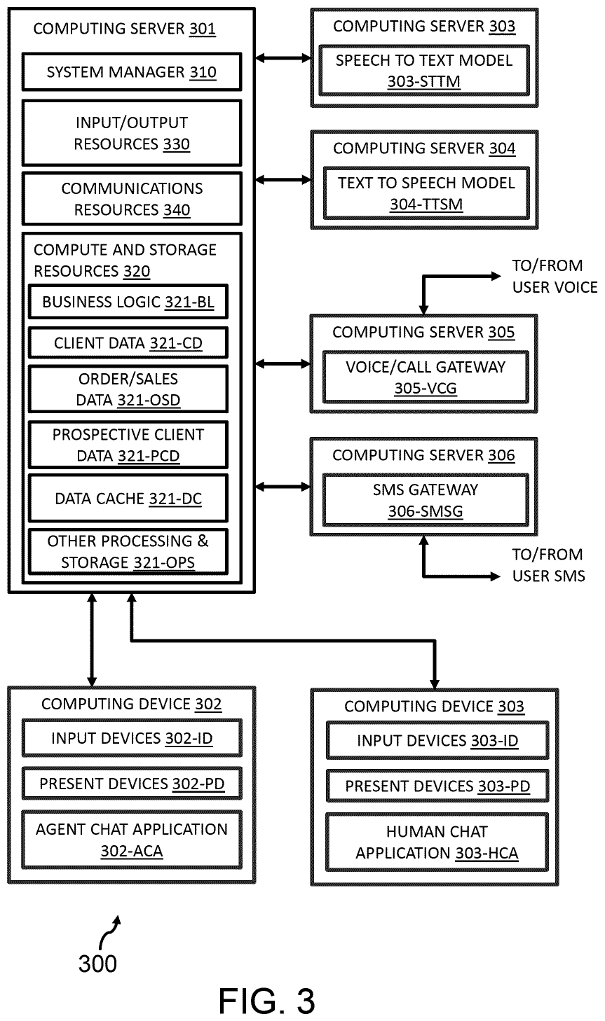

FIG. 3 depicts a high-level block diagram of a system suitable for use in implementing the various embodiments. Specifically, the system 300 of FIG. 3 comprises one or more data processing elements, computing devices, network elements and the like cooperating as described herein to implement various embodiments. Not all of the described data processing elements, computing devices, network elements and the like are necessary to implement each embodiment. The exemplary system described herein is provided for illustrative purposes only. For example, the system 300 of FIG. 3 may be implemented via one or more servers, workstations, data centers and/or other computing and memory providing devices operating in accordance with the various embodiments, such as described herein and with respect to the various other figures. For example, the system 300 of FIG. 3 may be implemented within the context of one or more data centers having instantiated therein compute and memory/storage resources configured in accordance with the embodiments described herein.

As shown in FIG. 3, a first computing server 301 is depicted as comprising a system manager 310, compute (processing) and storage (memory) resources 320, input/output resources 330, and communications resources 340. Generally speaking, the system manager 310 may be used to control various aspects of the first computing server 301 such as the configuration or operational control of the individual elements of the first computing server 301, the managing of resources within the first computing server 301, and so on. In various embodiments a system manager 110 is not used (i.e., the individual elements are configured for operation without the use of a local system manager 110).

The input/output (I/O) resources or interface(s) 130 may be configured to enable communication between the first computing server 301 and various presentation devices (not shown) and/or input devices (not shown) directly coupled to the first computing server 301.

The communications resources 140 are configured to enable communication between the first computing server 301 and a network used to transfer data between the first computing server 301 other computing servers (e.g., computing servers 303-306), computing devices (e.g., computing devices 302-303), and remote computing servers, devices, and the like (not shown). Such communications may be implemented via any combination of the internet, edge networks, corporate networks, wired and wireless networks and so on to enable thereby communications between the first computing server 301 and the various other computing servers, devices, and the like as described herein and/or depicted in FIG. 3.

As shown in FIG. 3, the compute and storage resources 320 of the first computing server 301 are used to implement various processors or modules in accordance with the embodiments such as the methods described above with respect to FIGS. 1-2. Specifically, the compute and storage resources 320 are depicted as including various modules comprising hardware or a combination of hardware and software configured to implement various functions, such as processing functions implementing business logic 321-BL (e.g., the methods described above with respect to FIGS. 1-2), storage functions such as for client data 321-CD, order/sales data 321-OSD, prospective client data 321-PCD, and a data cache 321-DC, and various other processing and storage functions 321-OPS.

As depicted in FIG. 3, the first computing server 301 communicates with a first computing device 302 and a second computing device 303, each of which includes respective compute (processing) resources, storage (memory) resources, and input/output resources. These resources, while not specifically identified in FIG. 3, support the operation of an agent chat application 302-ACA in first computing device 302 and a human chat application 303-HCA in second computing device 303. These chat application may be configured to support the agent chat and human chat functions described above with respect to FIGS. 1-2.

In particular, first computing device 302 is depicted as including an input device 302-ID and presentation devices 302-PD. Similarly, second computing device 303 is depicted as including an input device 303-ID and presentation devices 303-PD. The input devices ID may comprise touch screen or keypad input devices for enabling user text input and audio input devices for enabling user voice input. The presentation devices PD may comprise display or presentation devices for displaying data, video, audio, and the like and audio output devices for enabling user voice output, as well as various combinations thereof.

As depicted in FIG. 3, the first computing server 301 communicates with a second computing server 303, third computing server 304, fourth computing server 305, and fifth computing server 306, each of which includes respective compute (processing) resources, storage (memory) resources, and input/output resources. These resources, while not specifically identified in FIG. 3, support the operation of a speech to text model 303-STTM in second computing server 303 configured to provide speech-to-text functions as described herein, a text to speech model 304-TTSM in third computing server 304 configured to provide text-to-speech functions as described herein, a voice/call gateway 305-VCG in fourth computing server 305 configured to provide voice/call telephony access to the system 100 by users such as via a voice over IP (VOIP) network or other communications network(s), and a short message service (SMS) gateway 306-SMSG configured to provide SMS/text/other messaging access to the system 100 by users such as via a VoIP network or other communications network(s). While depicted as individual computing servers 303-305, the functions of computing servers 303-305 may be implemented using more or fewer servers.

The various embodiments described above contemplate a method for sustaining one or more semi-or fully-autonomous conversations between at least one human and at least one artificial intelligence agent. The method may comprise (a) receiving first speech from a human; (b) converting the first speech to first text via a speech-to-text language model; (c) allowing an artificial intelligence agent to generate a second text responsive to the first text via a generative language model operably linked to a first database, the database being a production database or a copy of a production database; (d) converting the second text to second speech via a text-to-speech language model; and (e) transmitting the second speech to the human. Some or all of these steps may be repeated.

In various embodiments, the production database hosts one or more of customer data, customer orders, and order management data.

In various embodiments, the production database hosts prospect and/or sales data.

In various embodiments, the methods allow the artificial intelligence agent to perform an action responsive to a first text. The action may comprise, illustratively, modifying one or more records in a first database; cancelling or starting a new order for a human; retrieval, addition, or modification of customer data; determine/define order status, payment information, delivery address, or a combination thereof.

In various embodiments, the generative language model is configured to maintain an ongoing memory of previous conversations with that customer or any subset of customers, utilizing human-and/or machine-readable data structures, a language model finetuning process, a language model training process, a language model prefix tuning process, and/or a combination thereof.

In various embodiments, after generating the second text, allowing an agent to send a message to the human. The message may be a text message, SMS message, web-based chat message, and so on.

In various embodiments, a text, via text message or a web-based text chat, is received instead of speech in step (a), and text, via text message or a web-based text chat, is transmitted instead of speech in step (e), and steps (b) and (d) are optionally bypassed.

In various embodiments, the system maintains a separate production database and a cache database, the cache database being a deep or shallow copy of the production database. Each deep or shallow copy may be made, illustratively, 15 minutes to 12 hours after a previous deep or shallow copy was made. Each deep or shallow copy may be made 12 or more hours after a previous deep or shallow copy was made.

Various embodiments contemplate allowing the artificial intelligence agent to generate or execute or reference functions that directly interact with the cache database. These embodiments may further comprise a human or machine reviewing one or more diffs in batches, where each diff defines one or more changes in the cache database from the production database.

Various embodiments further comprise allowing the changes to be written to the production database.

Various embodiments further comprise delaying after generating second text and before transmitting the second speech.

Various embodiments further comprise allowing a human agent to prevent further interaction between the human and the artificial intelligence agent. Such preventing may include allowing the human agent to communicate with the human via a text message.

In various embodiments, either human agent or artificial agent or customer/user has a way to disconnecting from the conversation, preventing further voice or text from being sent to them.

Various modifications may be made to the systems, methods, apparatus, mechanisms, techniques, and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method for sustaining one or more semi-or fully-autonomous conversations between at least one human and at least one artificial intelligence agent, comprising:
(a) receiving first speech from a human;
(b) converting the first speech to first text via a speech-to-text language model;
(c) allowing an artificial intelligence (AI) agent to generate second text responsive to the first text via a generative language model operably linked to a first database, the database being a production database or a copy of a production database;
(d) converting the second text to second speech via a text-to-speech language model; and
(e) transmitting the second speech to the human.

2. The method of claim 1, wherein the production database hosts at least one of customer data, customer orders, order management, prospect data, and sales data.

3. The method of claim 1, further comprising allowing the AI agent to perform an action responsive to the first text.

4. The method of claim 3, wherein the action includes at least one of modifying one or more records in the first database, cancelling or starting a new order for the human, and retrieval, addition, or modification of customer data.

5. The method of claim 4, wherein the customer data includes order status, payment information, delivery address, or a combination thereof.

6. The method of claim 1, wherein the generative language model is configured to maintain an ongoing memory of previous conversations with that customer or any subset of customers, utilizing: human-and/or machine-readable data structures, a language model finetuning process, a language model training process, a language model prefix tuning process, or a combination thereof.

7. The method of claim 1, further comprising repeating steps (a)-(e).

8. The method of claim 7, further comprising, after generating second text, allowing an agent to send a message to the human.

9. The method of claim 1, wherein:
text, via text message or a web-based text chat, is received instead of speech in step (a);
text, via text message or a web-based text chat, is transmitted instead of speech in step (e); and
steps (b) and (d) are optionally bypassed.

10. The method of claim 1, further comprising maintaining a separate production database and a cache database, the cache database being a deep or shallow copy of the production database.

11. The method of claim 10, wherein each deep or shallow copy is made 15 minutes to 12 hours after a previous deep or shallow copy was made.

12. The method of claim 10, further comprising allowing the artificial intelligence agent to generate or execute or reference functions that directly interact with the cache database.

13. The method of claim 12, further comprising a human or machine reviewing one or more diffs in batches, where each diff defines one or more changes in the cache database from the production database.

14. The method of claim 13, further comprising allowing the changes to be written to the production database.

15. The method of claim 1, further comprising delaying after generating second text and before transmitting the second speech.

16. The method of claim 15, further comprising allowing a human agent to prevent further interaction between the human and the artificial intelligence agent.

17. The method of claim 16, wherein preventing further interaction includes allowing the human agent to communicate with the human via a text message.

18. A computer implemented method for sustaining one or more semi-or fully-autonomous conversations between at least one human and at least one artificial intelligence agent, comprising:
(a) receiving first speech from a human;
(b) converting the first speech to first text via a speech-to-text language model;
(c) allowing an artificial intelligence (AI) agent to generate second text responsive to the first text via a generative language model operably linked to a first database, the database being a production database or a copy of a production database;
(d) converting the second text to second speech via a text-to-speech language model; and
(e) transmitting the second speech to the human.

19. A system for sustaining one or more semi-or fully-autonomous conversations between at least one human and at least one artificial intelligence agent, comprising:
a server configured for:
(a) receiving first speech from a human via a voice gateway;
(b) converting the first speech to first text via a speech-to-text language model;
(c) allowing an artificial intelligence (AI) agent to generate second text responsive to the first text via a generative language model operably linked to a first database, the database being a production database or a copy of a production database;
(d) converting the second text to second speech via a text-to-speech language model; and
(e) transmitting the second speech to the human via the voice gateway.

20. The system of claim 19, wherein the server is further configured for:
text, via text message or a web-based text chat, is received via a SMS gateway instead of speech in step (a);
text, via text message or a web-based text chat, is transmitted via the SMS gateway instead of speech in step (c); and
steps (b) and (d) are optionally bypassed.
